(19) United States
(12) Patent Application Publication
(10) Pub. No.: US 2006/0277081 A1
(43) Pub. Date: Dec. 7, 2006

(54) ESTIMATES TO ACTUALS TRACKING TOOL AND PROCESS

(76) Inventors: Kiet D. Pham, Charlotte, NC (US); Jason Latta, Charlotte, NC (US); Satyan Noupada, Charlotte, NC (US); Chris Welles, Charlotte, NC (US); Kevin Rodriguez, Charlotte, NC (US)

Correspondence Address: MOORE & VAN ALLEN PLLC, P.O. BOX 13706, Research Triangle Park, NC, 27709, US

(21) Appl. No.: 11/160,007

(22) Filed: Jun. 6, 2005

(51) Int. Cl. G06F 17/50

(52) U.S. Cl. 705/7

(57) ABSTRACT

A method for automated risk management may include presenting a rule request graphical user interface (GUI) for a requester to enter information related to a rule request for a rule. The method may also include determining a risk rating score for the rule based on information entered in the rule request GUI. The information may include at least one of source information, destination information, service information and port information.

### COPYRIGHT NOTICE

A portion of the disclosure of this patent document contains material that is subject to copyright protection. The copyright owner has no objection to the facsimile reproduction by anyone of the patent document, or the patent disclosure, as it appears in the Patent and Trademark Office patent files or records, but otherwise reserves all copyright rights whatsoever.

### BACKGROUND OF THE INVENTION

The present invention relates to estimating and tracking parameters associated with projects or initiatives, such as man-hours, costs, and the like, and more particularly to an estimates to actuals tracking tool and process.

Accurately estimating parameters, such as man-hours, costs and the like for projects or initiatives can be challenging. This may be particularly true for initiatives related to software development where there may be no standard methodology, process or metric for estimating the complexity of initiatives across different phases of a software development initiative or program. Examples of different software development phases may include a high level design (HDL) phase, a low level design (LLD) phase, a build phase and testing processes phase. There may also be a lack of standardization, methodology, processes or metric within a organization or industry for tracking and reporting parameters and data for initiatives across different phases of development.

### SUMMARY OF THE INVENTION

In accordance with an embodiment of the present invention, a method for estimating parameters and tracking actual parameters for an initiative may include estimating a parameter for the initiative based on responses to a set of questions. The method may also include tracking actual data for the parameter during progression or development of the initiative.

In accordance with another embodiment of the present invention, an estimates to actuals tracking tool may include a data structure operable on a processor to estimate a parameter for an initiative based on responses to a set of questions. The tool may also include a data structure operable on the processor to track actual data for the parameter during progression of the initiative.

In accordance with a further embodiment of the present invention, a computer program product for estimating parameters and tracking actual parameters for an initiative may include a computer readable medium having computer readable program code embodied therein. The computer readable medium may include computer readable program code configured to estimate a parameter for an initiative based on responses to a set of questions. The computer readable medium may also include computer readable program code configured to track actual data for the parameter during progression of the initiative.

Other aspects and features of the present invention, as defined solely by the claims, will become apparent to those ordinarily skilled in the art upon review of the following non-limited detailed description of the invention in conjunction with the accompanying figures.

### DESCRIPTION OF THE DRAWINGS

FIGS. 1A-1C (collectively FIG. 1) are a flow chart of an example of a method for estimating parameters and tracking actual parameters for an initiative in accordance with an embodiment of the present invention.

FIG. 2 is an example of an “Initiatives” graphical user interface (GUI), web page or the like of an estimates to actuals tracking tool and process for presenting initiatives and adding, editing or deleting an initiative in accordance with an embodiment of the present invention.

FIGS. 3A and 3B (collectively FIG. 3) are an example of an “Estimate” GUI, web page or the like of an estimates to actuals tracking tool and process for presenting entities and adding, editing or deleting an entity in accordance with another embodiment of the present invention.

FIG. 4 is an example of an “Add Entity” GUI, web page or the like of an estimates to actuals tracking tool and process for adding an entity in accordance with an embodiment of the present invention.

FIG. 5 is an example of a GUI, web page or the like of an estimates to actuals tracking tool and process for entering information or responding to questions about an entity in accordance with an embodiment of the present invention.

FIG. 6 is an example of an “Initiatives Estimates” report generable by an estimates to actuals tracking tool and process in accordance with an embodiment of the present invention.

FIG. 7 is an example of a “Phase Cost Comparison” chart generable by an estimates to actuals tracking tool and process in accordance with an embodiment of the present invention.

FIGS. 8A and 8B (collectively FIG. 8) are examples of phase cost distribution charts generable by an estimates to actuals tracking tool and process in accordance with an embodiment of the present invention.

FIGS. 9A, 9B and 9C (collectively FIG. 9) are an example of an entities and resources detail report generable by an estimates to actuals tracking tool and process in accordance with an embodiment of the present invention.

FIG. 10 is an example of an “Initiatives” GUI, web page or the like of an estimates to actuals tracking tool and process for impact assessment in accordance with an embodiment of the present invention.

FIG. 11 is an example of a GUI, web page or the like of an estimates to actuals tracking tool and process to present impact guidelines in accordance with an embodiment of the present invention.

FIG. 12 is an example of an “Impact Assessment” initiative report generable by an estimates to actuals tracking tool and process in accordance with an embodiment of the present invention.

FIG. 13 is an example of an impact assessment “Weekly Report” generable by an estimates to actuals tracking tool and process in accordance with an embodiment of the present invention.

FIGS. 14A and 14B (collectively FIG. 14) is an example of an “Entity Actuals by Phase” GUI, web page or the like of an estimates to actuals tracking tool and process to present entity actuals by phase in accordance with an embodiment of the present invention.

FIG. 15 is an example of a cost analysis and time analysis chart generable by an estimates to actuals tracking tool and process in accordance with an embodiment of the present invention.

FIG. 16 is an example of an “Initiatives Details” GUI, web page or the like of an estimates to actuals tracking tool and process in accordance with an embodiment of the present invention.

FIG. 17 is an example of an of a “Resource Actuals by Week” GUI, web page or the like of an estimates to actuals tracking tool and process in accordance with an embodiment of the present invention.

FIG. 18 is an example of an “Entity Types” GUI, web page or the like of an estimates to actuals tracking tool and process to add, edit or delete entity details in accordance with an embodiment of the present invention.

FIG. 19 is an example of an “Entity Factors” GUI, web page or the like of an estimates to actuals tracking tool and process to add, edit or delete factors associated with an entity in accordance with an embodiment of the present invention.

FIG. 20 is an example of a “Resources” GUI, web page or the like of an estimates to actuals tracking tool and process to add, edit or delete resources in accordance with an embodiment of the present invention.

FIG. 21 is an example of a “Modify Resource Types” GUI, web page or the like of an estimates to actuals tracking tool and process to modify resource type information in accordance with an embodiment of the present invention.

FIG. 22 is a block diagram of exemplary system incorporating a estimates to actuals tracking tool or the like in accordance with an embodiment of the present invention.

### DETAILED DESCRIPTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk or C++ or the like. However, the computer program code for carrying out operations of the present invention may also be written in conventional procedural programming languages, such as the “C” programming language or similar programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

As used herein, Standard Software Process (SSP) is a structured phase approach to software development or the like that may be applied to the estimates to actuals tool of the present invention. Phased approaches other than SSP could also be used and are configurable depending on the desired usage.

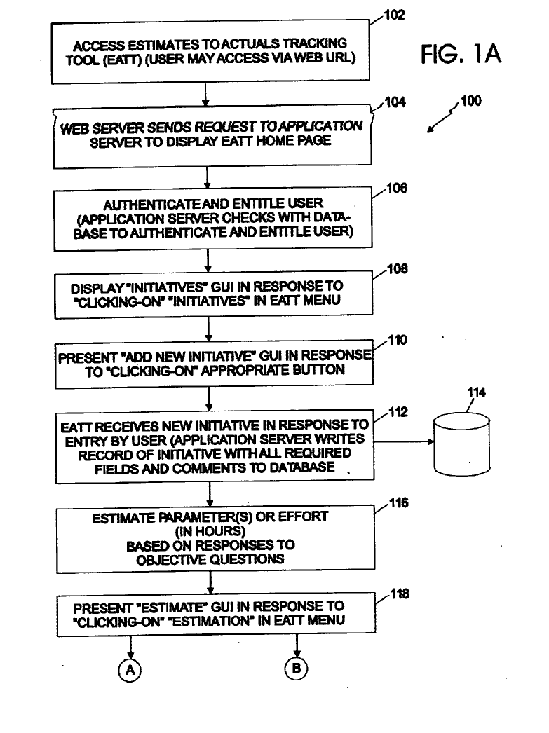

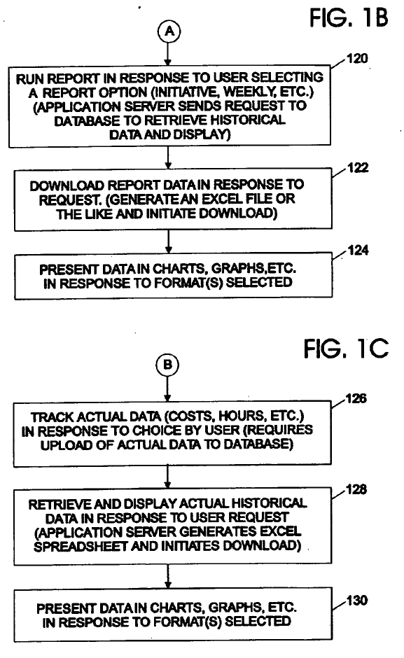

FIGS. 1A-1C (collectively FIG. 1) are a flow chart of an example of a method 100 for estimating parameters and tracking actual parameters for an initiative in an estimates to actuals tracking tool in accordance with an embodiment of the present invention. In block 102, an estimates to actuals tracking tool (EATT) or the like may be accessed. The EATT may be accessed via a “web universal resource locator or the like. The EATT may be accessed via a network, such as the Internet, private network or intranet or the like.

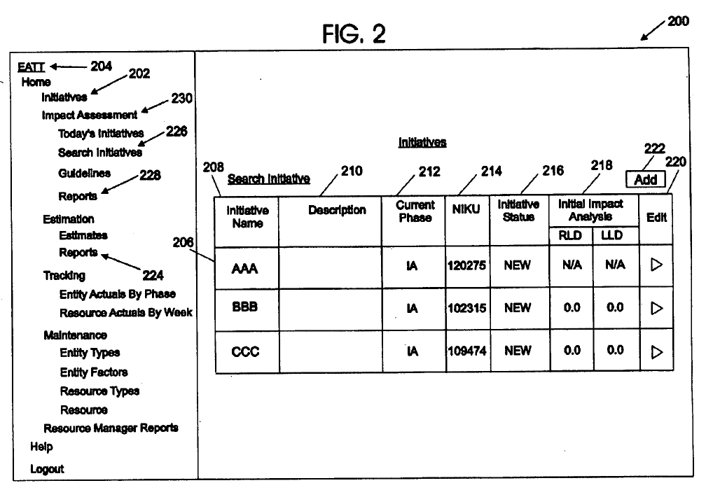

In block 104, a web server or similar server may send a request to an application server or the like to display an EATT home page. In block 106, a user attempting to access the EATT may be authenticated and entitled to access the tool. The application server may check with a database to confirm the user name, password or other information entered by the user to authenticate and entitle the user. If the user is authenticated and entitled, in block 108, an “Initiatives” GUI may be displayed or presented to the user in response to the user selecting “Initiatives” in an EATT menu. An example of an “Initiatives” GUI will be described in more detail with respect to FIG. 2 and an EATT menu will be described in more detail with respect to the example GUIs in FIGS. 2-34. The “Initiatives” GUI and other GUIs described herein may be selected by “clicking-on” or otherwise selecting or activating an option, link or the like using a computer pointing device, such as a mouse or similar device.

In block 110, a “Add New Initiative” GUI may be presented in response to selecting or “clicking-on” an appropriate button as will be described with reference to FIG. 2 herein. An initiative may be a project to develop software for a particular application or function or other project that may be related to a business operation. In block 112, the EATT may receive a new initiative or information related to a new initiative in response to entry by the user. The application server may write a record of the initiative with all required fields and comments to a database 114.

In block 116, parameters related to effort or the like associated with the initiative may be estimated based on responses to objective questions by the user. The parameters or effort estimated may be in hours, man-hours, or similar metric. Other parameters or variables that may be associated with an initiative or project may be estimated as well.

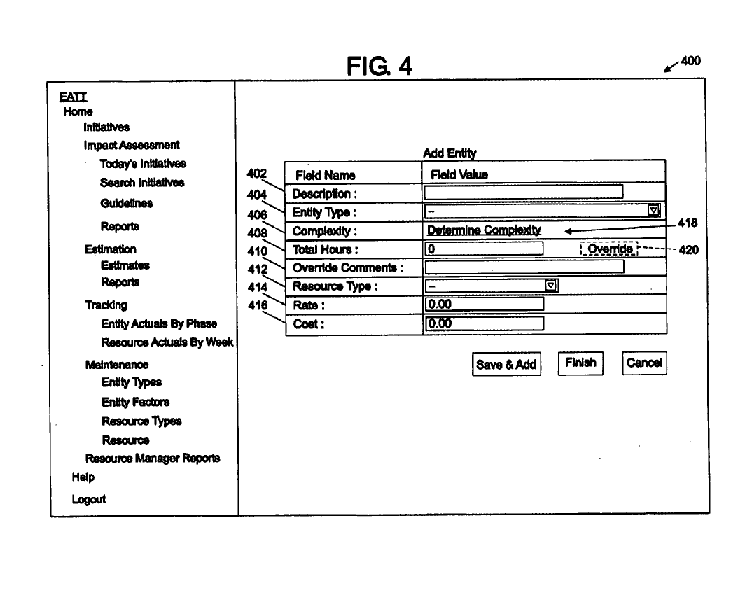

In block 118, an “Estimate” GUI may be presented in response to “clicking-on” or selecting an “Estimation” option in the EATT menu. The “Estimate” GUI may present entity details and permit adding, editing and deleting entities and entity types associated with an initiative. An entity may be anything that may need to be delivered as part of an initiative or phase of an initiative or any activity that may need to be performed in as part of an initiative or phase of an initiative. An example of an “Estimate” GUI and related GUIs and entities will be discussed in more detail with reference to FIG. 4 and subsequent Figures.

In block 120, a report may be run or generated in response to a user selecting a report option in the EATT menu. Examples of the different reports that may be generated by the EATT will be discussed in more detail herein. For example, reports may be generated for the initiative, weekly impact and the like. The application server or the like may send a request to the database 114 to retrieve any data or information that may be needed to generate the selected report. In block 122, any report data may be downloaded to the user in response to the request in block 120. A Microsoft Excel™ file or the like may be generated. Excel in a trademark of the Microsoft Corporation in the United States, other countries, or both. In block 124, the data may be presented in charts, graphs, tables or the like in response to a format or formats that may be selected by the user.

In block 126, actual data associated with an initiative may be tracked by the EATT in response to choice or selection by the user. The data tracked may include costs, hours to perform particular tasks or entities associated with the initiative or other data that may be associated with the initiative or entities. Tracking actual data may require uploading the actual data to a database, such as database 114.

In block 128, the actual historical data may be retrieved and displayed or presented in response to a request from the user. The application server may generate an Excel™ spreadsheet or the like and initiate a download of the data for generating a report or presenting the data or information. In block 130, the data or information may be presented in charts, graphs, tables or the like in response to a format or formats selected by the user as will be described in more detail with reference to other figures.

While the set of blocks 120, 122 and 124; and the set of blocks 126, 128 and 130 are illustrated as both coming from block 118, this is not intended to imply that these sets of blocks may be alternative to one another or that the functions may be performed simultaneously; although such may be the case.

FIG. 2 is an example of an “Initiatives” graphical user interface (GUI) 200, web page or the like of an estimates to actuals tracking tool and process for presenting initiatives and adding, editing or deleting an initiative in accordance with an embodiment of the present invention. The “Initiative” GUI 200 may be presented by selecting an “Initiatives” option 202 or link in an EATT menu 204. The “Initiatives” GUI 200 may include a table with multiple rows and columns. Each row 206 may correspond to an initiative and each column may contain information related to that initiative. Examples of the different information related to an initiative, and as labeled in a heading of each column, may include an “Initiative Name” column 208, a “Description” column 210, a “Current Phase” column 212, an “NIKU” column 214 or an identification number that may refer to a project and to which employees may account for time worked on the project, an “Initiative Status” column 216, an “Initial Impact Analysis” column 218, an “Edit” column 220 or similar columns for other information related to an initiative. The “Initial Impact Analysis” column 218 may include an “HLD” or High Level Design column and an “LLD” or Low Level Design column.

An “Add New Initiative” GUI (not shown in the drawings) may be presented in response to a user “clicking-on” or operating the “Add” button 222 or the like in GUI 200. “Add New Initiative” GUI may include a plurality of fields for entering or selecting parameters or information related to an initiative to be added. Examples of the different fields as labeled in GUI may include an “Initiative Name” field, a “CR #” field or “Change Request” number that may be used in project management to account for time worked or to which other items may be charged, an “NIKU” field, a “Description” field, a “Current Phase” field, a “Current Status” field, a “Document Type” field, a “Dispatcher” field, a “Dispatch Date (MM/DD/YY)” field, a “Line of Business” field, an “Approach” field or similar fields related to an initiative.

An “Update Initiative” GUI (not shown in the drawings) similar to the “Add New Initiative” GUI may be presented in response to “clicking-on” or selecting the icon in the “Edit” column 220 for an initiative 206 to edit the information related to the initiative 206 selected. The information or parameters that may be edited may be similar to those described with respect to the “Add New Initiative” GUI.

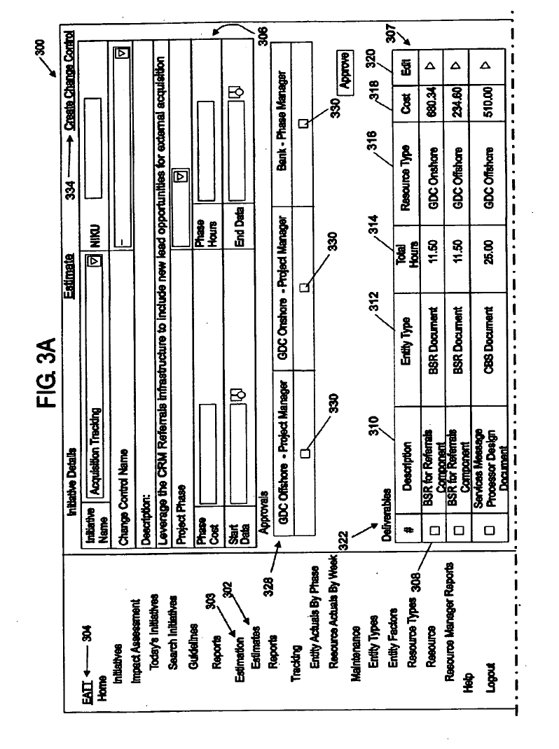

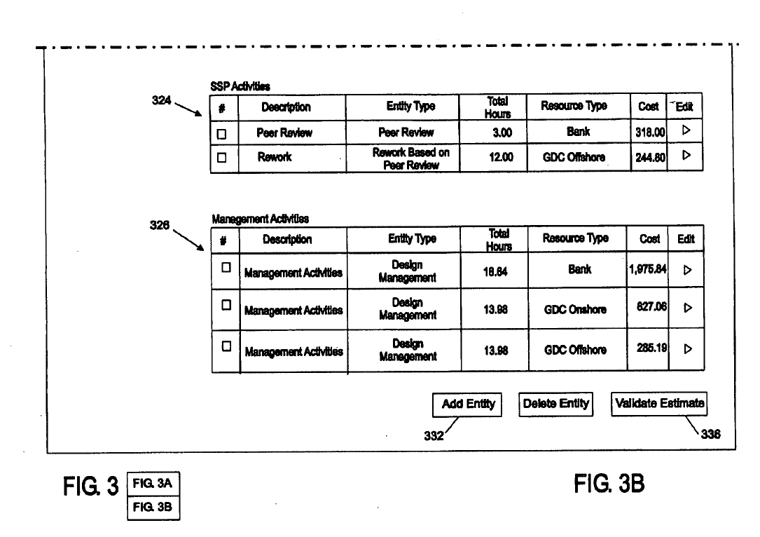

FIGS. 3A and 3B (collectively FIG. 3) are an example of an “Estimate” GUI 300, web page or the like of an estimates to actuals tracking tool and process for presenting entities and adding, editing or deleting an entity in accordance with an embodiment of the present invention. The GUI 300 may be presented in response to selecting an “Estimates” option 302 or link under an “Estimation” subheading 303 in an EATT menu 304. The EATT menu 304 may be same as the EATT menu 204 in FIG. 2. The “Estimate” GUI 300 may present initiative details 306 that may have been entered in association with the initiative being presented in GUI 300 and similar to the information entered in the “Add New Initiative” GUI. The “Estimate” GUI 300 may also present a table 307 with multiple rows 308 and columns 310-320. Each row 308 may correspond to an entity and each column 310-320 may correspond to information or parameters associated with the entity in the row 308. Examples of the information or parameters that may correspond to the information in each column may include a “Description” of the entity column 310, an “Entity Type” column 312, a “Total Hours” column 314, a “Resource Type” column 316, a “Cost” column 318 an “Edit” column 320 or other columns for similar information or parameters related to an entity.

The table 307 may be divided into different sections corresponding to different categories of entities. Examples of different categories of entities and sections may include, a “Deliverables” section 322, an “SSP” section 324 (Standard Software Process), and a “Management Activities” section 326 or similar sections.

The “Estimates” GUI 300 may also include an “Approvals” section 328. The “Approvals” section 328 may include boxes 330 for different managers to approve the entities listed for the initiative presented in GUI 300.

The “Estimates” GUI 300 may also include a “validate Estimates” link 336 or button. A page (not shown) displaying all unassigned entities for the selected phase may be displayed in response to “clicking-on” the Validate Estimate” link 336. This may be a cross-check to alert a user of entities which may not have been included in the estimate.

FIG. 4 is an example of an “Add Entity” GUI 400, web page or the like of an estimates to actuals tracking tool and process for adding an entity in accordance with an embodiment of the present invention. The “Add Entity” GUI 400 may be presented in response to selecting or “clicking-on” an “Add Entity” button 332 or the like in GUI 300 of FIG. 3. The “Add Entity” GUI 400 may include different fields 402-416 for entering parameters or information about an entity being added. Examples of the different fields for entering parameters, values or information may include a “Description” field 402 for the entity, an “Entity Type” field 404, a “Complexity” field 406, an “Override Comments” field 410, a “Resource Type” field 412, a “Rate” field 414, a “Cost” field 416 or similar fields. Entering the parameters or information in the different fields 402-416 may correspond to responses to questions for estimating parameters or effort in block 116 of the method 100 of FIG. 1.

In an “Update Entity” GUI (not shown) that may be similar to the “Add Entity” GUI 400 except an “Override” button 420 or link, as illustrated in FIG. 4, may be provided to permit a manager to override a “Determine Complexity” 418 outcome and add comments in field 410 explaining why the complexity outcome has been overridden. The “Override” button 420 may only be available to managers and this permission feature may be based on the user who is logged in. The GUI 400 presented to a non-manager would not include the “Override” button 420.

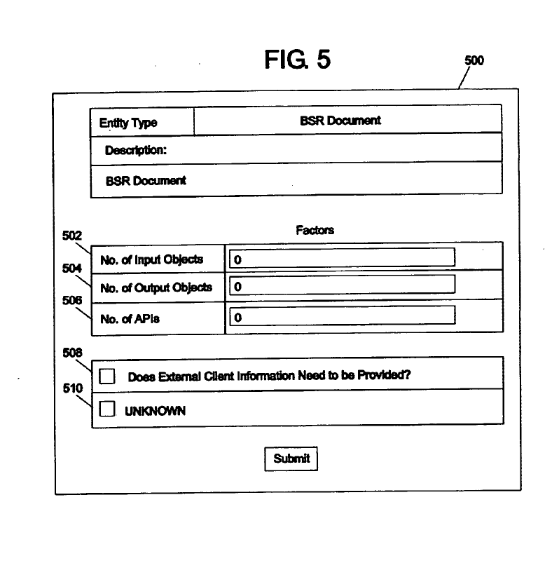

FIG. 5 is an example of a GUI 500, web page or the like of an estimates to actuals tracking tool and process for entering information or responding to questions about an entity in accordance with an embodiment of the present invention. The GUI 500 may be presented in response to selecting or “clicking-on” the option “Determine Complexity” 418 associated with the “Complexity” field 406 in GUI 400 (FIG. 4). The GUI 500 may include additional fields or boxes 502-510 into which information may be entered for estimating parameters or effort in block 116 of the method 100 (FIG. 1) based on the responses to objective questions which may correspond, at least in part, to the fields or boxes 502-510. Examples of the fields and check boxes in GUI 500 may include a “No. of Input Objects” field 502, a “No. of Output Objects” field 504, a “No. of APIs” field 506 (Application Program Interface), a “Does External Client Information Need to be Provided?” check box 508 and an “Unknown” check box 510, or similar field or boxes. When the “Unknown” check box 510 is checked or used, the estimates to actuals tracking tool may substitute the running hours average for this entity across all known initiatives. No other option would be checked if the “Unknown box 510 is used. The “Unknown” box 510 may also be designated as a “Default” box.

A “Create New Change Control” GUI (not shown in the drawings) may be presented by “clicking-on” or activating a link 334 in GUI 300 (FIG. 3) that may be labeled “Create Change Control” or the like. The “Create Change Control” GUI may include a plurality of fields for entering parameter or information associated with controlling how changes may be made to the associated initiative indicated in GUI 300. Examples of the different fields may include a “Change Control Name” field, an “NIKU” field, a “Description” field, a “Current Phase” field, a “Current Status” field or the like.

A “Reports” GUI (not shown in the drawings) may be provided for entering information or parameters for generating an estimation report and may be presented in response to “clicking-on” or selecting a “Reports” link 224 in the EATT menu 204 (FIG. 2). The “Reports” GUI may include fields for entering or selecting values for generating the estimation report. Examples of the fields may include an “Initiative Name” field, a “Change Control Name” field, a “Phase Name” field or similar fields.

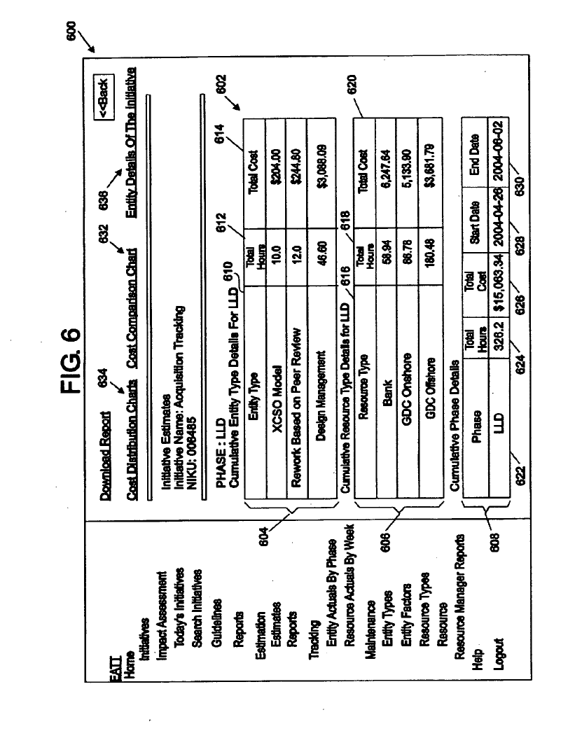

FIG. 6 is an example of an “Initiatives Estimates” report 600 generable by an estimates to actuals tracking tool and process in accordance with an embodiment of the present invention. The report 600 may be generated in response to entering values in the fields in the “Reports” GUI and “clicking-on” or operating a “submit” button in the “Reports” GUI (not shown). The entered values may then be applied by the EATT to retrieve the appropriate data or information to generate the report. The report 600 may present a table 602 including information related to the initiative named in the “Initiative Name” field and the phase selected in the “Phase Name” field of the “Reports” GUI. The report 600 may be divided into different sections. Examples of the different sections may include a “Cumulative Entity Type Details for the Phase” section 604, a “Cumulative Resource Type Details for the Phase” section 606, a “Cumulative Phase Details” section 608 and the like. The table 602 may also include multiple rows and columns. In section 604, each row may correspond to an entity type and each column may be labeled to represent information or data in each cell. Examples of the different columns and corresponding data or information in section 604 may include an “Entity Type” column 610, a total Hours” column 612, a “Total Cost” column 614 or the like.

In section 606, each row may correspond to a resource type and each column may be labeled to represent information or data contained in each cell. Examples of the different columns and corresponding information or data may include a “Resource Type” column 616, a “Total Hours” column 618, a “Total Cost” column 620 or similar columns and corresponding information.

In section 608, the row may correspond to the phase selected in the “Phase Name” field in the “Reports” GUI and each column may be labeled to represent information or data contained in each cell. Examples of the different columns and corresponding information or data may include a “Phase” column 622, a “Total Hours” column 624, a “Total Cost” column 626, a “Start Date” column 628, an “End Date” column 630 or similar columns and corresponding information.

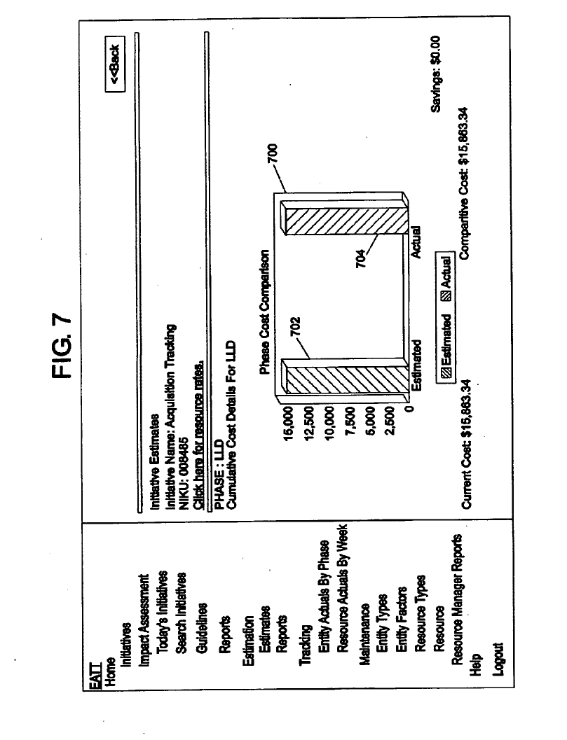

A FIG. 7 is an example of a “Phase Cost Comparison” chart 700 generable by an estimates to actuals tracking tool and process in accordance with an embodiment of the present invention. The “Phase Cost Comparison” chart 700 may be generated in response to “clicking-on” or activating a link 632 in GUI 600 (FIG. 6) that may be labeled “Cost Comparison Chart” or the like. The chart 700 may be a bar graph and may include a bar 702 representing estimated costs and a bar 704 representing actual costs for comparison. Each of the bars 702 and 704 may be represented in different colors or by other means to distinguish between them.

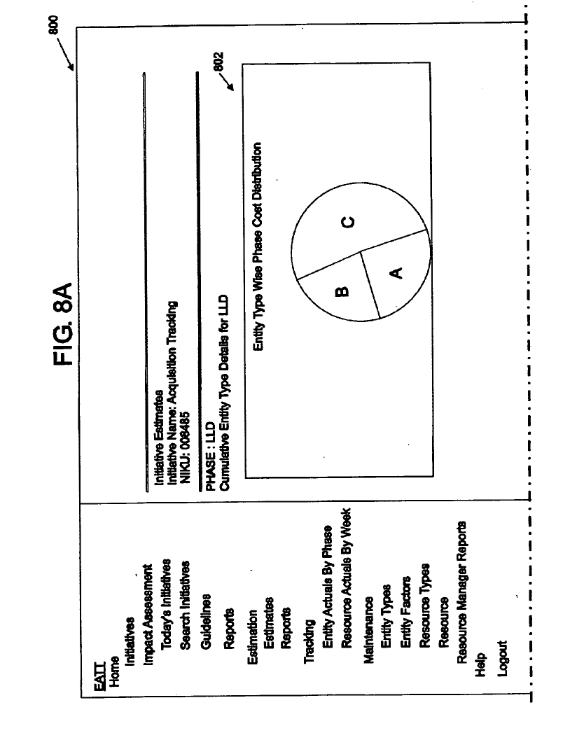

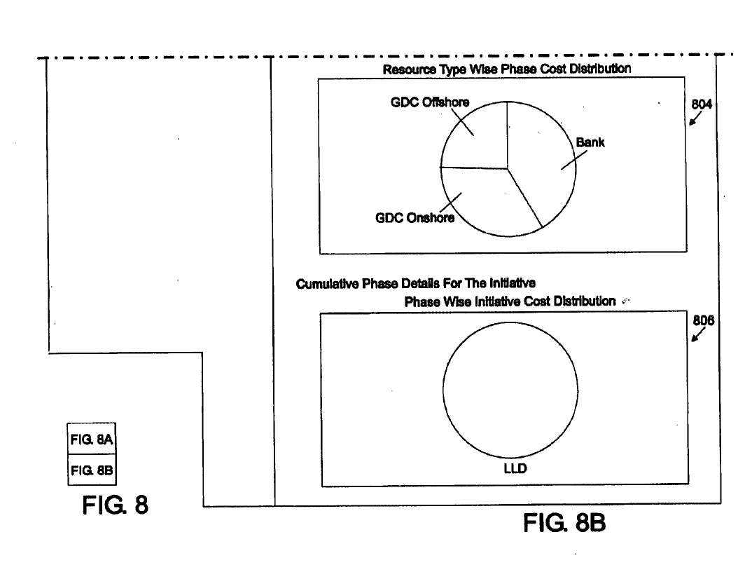

FIGS. 8A and 8B (collectively FIG. 8) are an example of a GUI 800 or screen shot of phase cost distribution charts 802-806 generable by an estimates to actuals tracking tool and process in accordance with an embodiment of the present invention. The GUI 800 may be presented in response to “clicking-on” or activating a link 634 in GUI 600 (FIG. 6) that may be labeled “Cost Distribution Charts” or a similar descriptive label. Examples of the phase cost distribution charts may include an “Entity Type Wise Phase Cost Distribution” chart 802, a “Resource Type Wise Phase Cost Distribution” chart 804, a “Phase Wise Initiative Cost Distribution” chart 806 or similar charts related to phase cost distributions or the like.

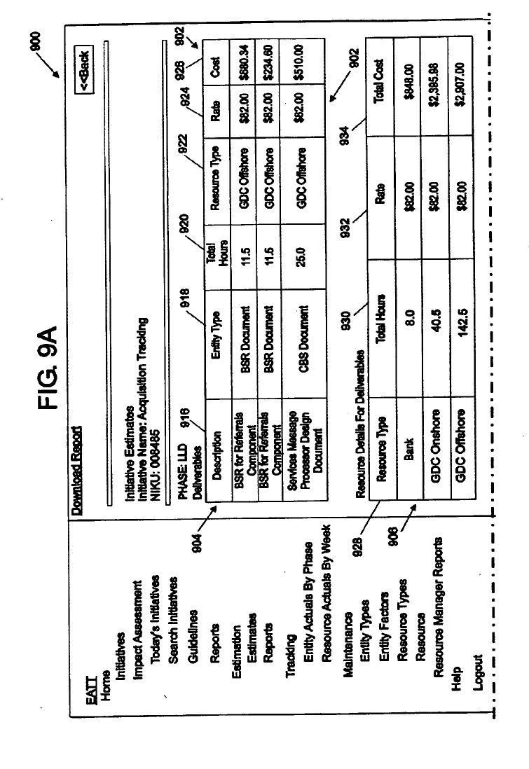

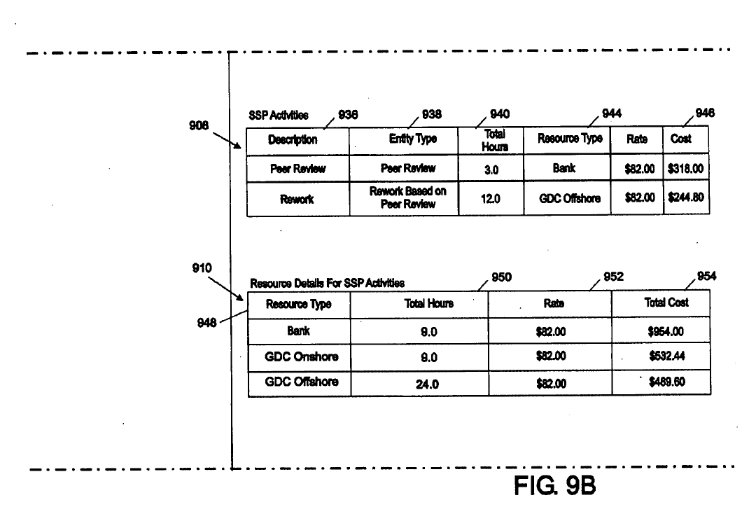

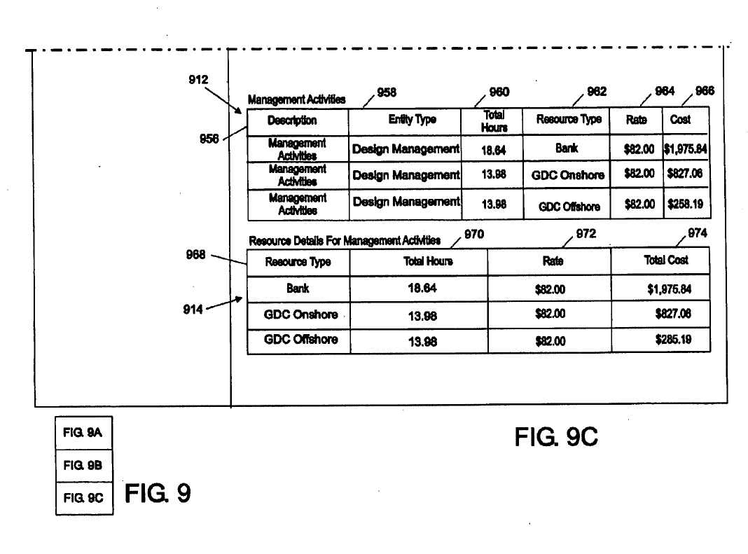

FIGS. 9A, 9B and 9C (collectively FIG. 9) are an example of an entities and resources detail report 900 generable by an estimates to actuals tracking tool and process in accordance with an embodiment of the present invention. The report 900 may be generated in response to “clicking-on” or activating a link 636 in GUI 600 (FIG. 6) that may be labeled “Entity Details of the Initiative” or a similar descriptive label. The report 900 may include a table 902 that may be divided into different sections. Examples of the different sections may include a “Deliverables” section 904, a “Resources Details for Deliverables” section 906, an “SSP Activities” section 908, a “Resource Details for SSP Activities” section 910, a “Management Activities” section 912, a “Resource Details for Management Activities” section 914, or similar sections.

In the “Deliverables” section 904, each row may represent an entity and each column may represent different information or data related to the entity and deliverable and may be labeled accordingly. Examples of the labels and corresponding information in each column may include a “Description” column 916, an “Entity Type” column 918, a “Total Hours” column 920, a “Resource Type” column 922, a “Rate” column 924, a “Cost” column or similarly labeled columns containing corresponding information related to deliverables for an entity. The rate information in the “Rate” column 924 and cost information in the “Cost” column 926 may be predetermined or standard rates for the particular deliverable or entity.

In the “Resource Details for Deliverables” section 906, each row may correspond to a resource type and each column may correspond to different information or data related to the resource and may be labeled accordingly. Examples of the labels and corresponding information in each column may include a “Resource Type” column 928, a “Total Hours” column 930, a “Rate” column 932, a “Total Cost” column 934, or similarly labeled columns and corresponding information and data. The rate information in the “Rate” column 932 may be predetermined or standard rates for the particular resource.

In the “SSP Activities” section 908, each row may correspond to an SSP Activity and each column may correspond to different information or data related to the SSP Activity and may be labeled accordingly. Examples of the labels and corresponding information in each column may include a “Description” column 936, an “Entity Type” column 938, a “Total Hours” column 940, a “Resource Type” column 942, a “Rate” column 944, a “Cost” column 946, or similarly labeled columns and corresponding information and data The rate information in the “Rate” column 944 may be predetermined or standard rates for the particular SSP activity.

In the “Resource Details for SSP Activities” section 910, each row may correspond to a resource type and each column may correspond to different information or data related to the resource type and may be labeled accordingly. Examples of the labels and corresponding information in each column may include a “Resource Type” column 948, a “Total Hours” column 950, a “Rate” column 952, a “Total Cost” column 954, or similarly labeled columns and corresponding information and data. The rate information in the “Rate” column 944 may be predetermined or standard rates for the particular for the resource.

In the “Management Activities” section 912, each row may correspond to a Management Activity and each column may correspond to different information or data related to the management activity and may be labeled accordingly. Examples of the labels and corresponding information in each column may include a “Description” column 956, an “Entity Type” column 958, a “Total Hours” column 960, a “Resource Type” column 962, a “Rate” column 964, a “Cost” column 966, or similarly labeled columns and corresponding information and data. The rate information in the “Rate” column 964 may be predetermined or standard rates for the particular management activity.

In the “Resource Details for Management Activities” section 914, each row may correspond to a resource type and each column may correspond to different information or data related to the resource type and may be labeled accordingly. Examples of the labels and corresponding information in each column may include a “Resource Type” column 968, a “Total Hours” column 970, a “Rate” column 972, a “Total Cost” column 974, or similarly labeled columns and corresponding information and data. The rate information in the “Rate” column 972 may be predetermined or standard rates for the particular for the resource.

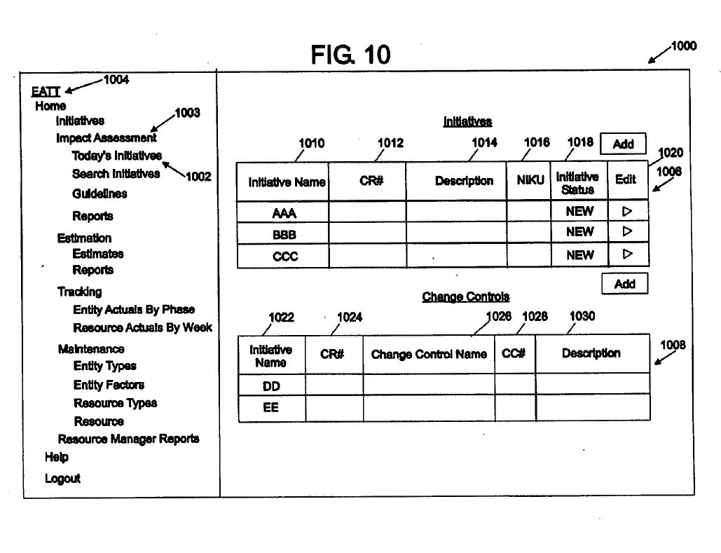

FIG. 10 is an example of an “Initiatives” GUI 1000, web page or the like of an estimates to actuals tracking tool and process for impact assessment in accordance with an embodiment of the present invention. The impact assessment “Initiatives” GUI 1000 may be presented in response to “clicking-on” or selecting a “Today's Initiatives” link 1002 under an “Impact Assessment” subheading 1003 in an EATT menu 1004. The EATT menu 1004 may be the same as the EATT menu 204 in GUI 200 of FIG. 2. The GUI 1000 may include an “Initiatives” table 1006 and a “Change Control” table 1008. The “Initiatives” table 1006 may include a plurality of rows and columns. Each row may correspond to an initiative and each column may correspond to data or information in each cell of the table 1006 related to the initiative and may be labeled accordingly. Examples of the columns and corresponding information or data may include an “Initiative Name” column 1010, a “CR #” column 1012, a “Description” column 1014, an “NIKU” column 1016, an “Initiative Status” column 1018, an “Edit” column 1020 or similar columns and information related to initiatives.

The “Change Controls” table 1008 may include a plurality of rows and columns. Each row may correspond to an initiative and each column may correspond to data or information related to the initiative and may be labeled accordingly. Examples of the columns and corresponding information or data may include an “Initiative Name” column 1022, a “CR #” column 1024, a “Change Control Name” column 1026, a “CC # or change control number column 1028, a “Description” column 1030 or similar columns and information related to initiatives and change controls.

A “Search Initiatives” GUI (not shown in the drawings) may be presented in response to “clicking-on” or activating a link 226 that may be labeled “Search Initiatives” under an “Impact Assessment” subheading in the EATT menu 204 (FIG. 2). The “Search Initiatives” GUI may include a plurality of fields for entering parameters or values related to different criteria for searching a database, such as database 114 in FIG. 1. Examples of the different fields for criteria that may be searched may include a “CR #” field, an “NIKU” field, an “Initiative Name” field, a “Current Phase” field, a “Dispatch Date (MM/DD/YY)” field or other fields for similar search criteria.

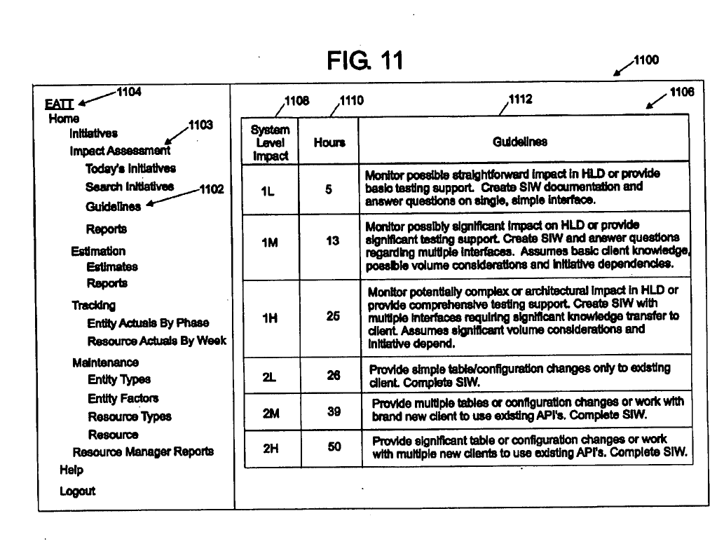

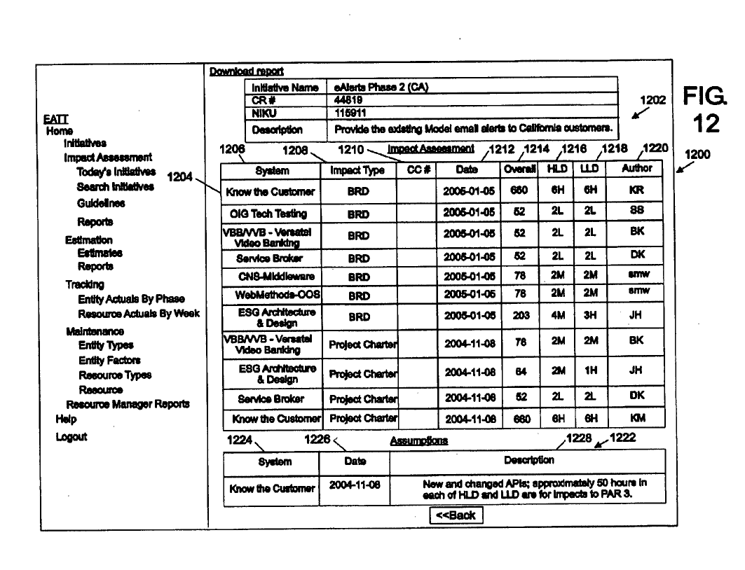

FIG. 11 is an example of a GUI 1100, web page or the like of an estimates to actuals tracking tool and process to present impact guidelines in accordance with an embodiment of the present invention. The GUI 1100 may be presented in response to “clicking-on” or activating a link 1102 that may be labeled “Guidelines” under an “Impact Assessment” subheading 1103 in an EATT menu 1104. The EATT menu 1104 may be the same as the EATT menu 204 in GUI 200 of FIG. 2. The GUI 1100 may include a table 1106 of guidelines and related system level impacts and a number of hours. The system level impact may be represented in a column 1108 of table 1106, an hours impact in column 1110 and corresponding guidelines in column 1112 of the table 1106. Examples of the impacts, hours and guidelines are illustrated in the GUI 1100.

A select report GUI (not shown in the drawings) may be presented in response to “clicking-on” or activating a link 228 that may be labeled “Reports” under an “Impact Assessment” subheading in the EATT menu 204 in FIG. 2. The reports that may be selected for presentation may be an “Initiative Report” or a “weekly Report.”.

FIG. 12 is an example of an “Impact Assessment” initiative report 1200 generable by an estimates to actuals tracking tool and process in accordance with an embodiment of the present invention. The “Impact Assessment” initiative report 1200 may be presented in response to selecting an initiative report in the “Reports GUI. The “Impact Assessment” report 1200 may include a table 1202 with multiple rows and columns. Each row 1204 may correspond to a different system. Each column may correspond to different information or data that may be contained in a cell associated with the intersection of a row and column. Examples of the data or information in each cell and the label for each column may include a “System” column 1206, an “Impact Type” column 1208, a “CC #” column 1210, a “Date” column 1212, an “Overall” column 1214, an “HLD” column 1216, an “LLD” column 1218, and an “Author” column 1220.

The “Impact Assessment” initiative report 1200 may also include an “Assumptions” table 1222. The “Assumptions” table 1222 may include information and columns labeled to indicate the information contained in each of the cells of the table. Examples of the information and column labeling may include a System” column 1224, a “Date” column 1226 and a “Description” column 1228.

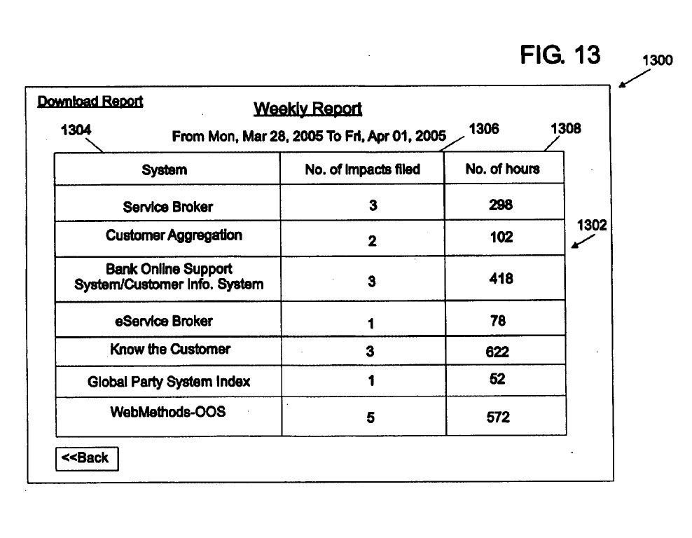

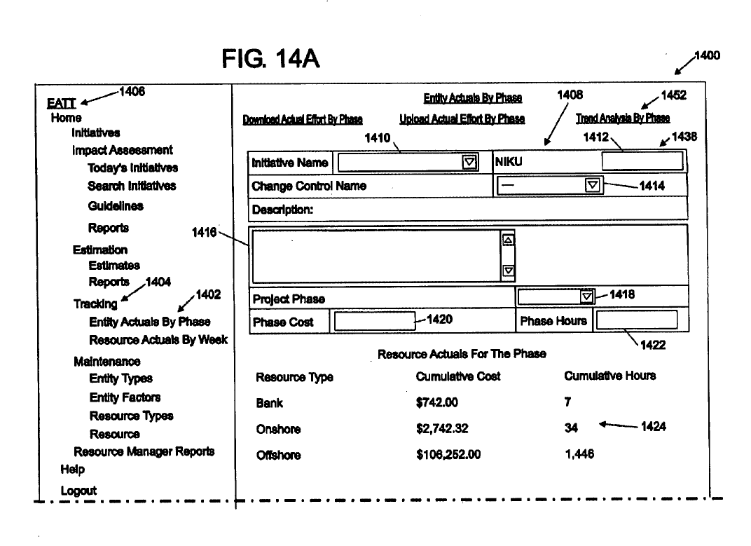

FIG. 13 is an example of an impact assessment Weekly Report 1300 generable by an estimates to actuals tracking tool and process in accordance with an embodiment of the present invention. The impact assessment “Weekly Report” may be generated in response to selecting “Weekly Report” in the “Reports” GUI. The impact assessment “weekly Report” 1300 may include a table 1302. Each row 1304 of the table 1302 may correspond to a system. Each column may have a label in a column heading that identifies the information or data contained in each cell of the table. Examples of the data or information and labels for each column heading may include a “System” column 1304, a “No. of impacts filed” column 1306 and a No. of hours” column 1308.

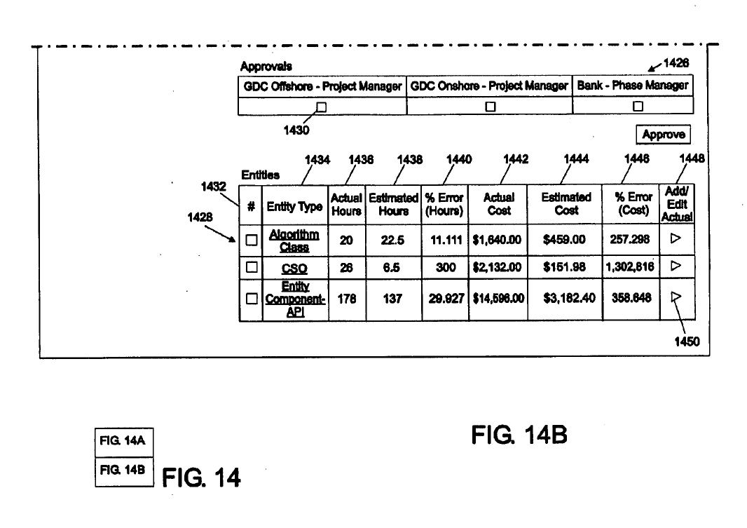

FIG. 14 is an example of an “Entity Actuals by Phase” GUI 1400, web page or the like of an estimates to actuals tracking tool and process to present entity actuals by phase in accordance with an embodiment of the present invention. The “Entity Actuals by Phase” GUI 1400 may be presented by “clicking-on” or activating a link 1402 that may be labeled “Entity Actuals by Phase” or a similar descriptive label under a “Tracking” subheading 1404 in an EATT menu 1406. The EATT menu 1406 may be the same as EATT menu 204 in GUI 200 (FIG. 2). The “Entity Actuals by Phase” GUI 1400 may present the estimated data or information compared to the actual data or information for an initiative by a selected phase of the initiative. The GUI 1400 may include a first section 1408 that may include a number of fields to select or enter the criteria for presenting the entity actuals compared to the estimated parameters. Examples of the fields that may be presented in first section 1408 may include an “Initiative Name” field 1410, an “NIKU” field 1412, a “Change Control Name” field 1414, a “Description” field 1416, a “Project Phase” field 1418 or similar fields that may be used to select an initiative or phase for presenting a comparison of estimated data to actual data Other fields, such as a “Phase Cost” field 1420 and “Phase Hours” field 1422 may be automatically populated according to the entries or selections in the other fields.

The “Entity Actuals by Phase” GUI 1400 may include a second section 1424 that may present resource actuals for the phase by resource type, cumulative cost, cumulative hours or similar parameters related to resources utilized for the initiative and phase selected in the first section 1408. The “Entity Actuals by Phase” GUI 1400 may also include an approvals section 1426 and a table 1428 for presenting different data for comparison. The approvals section 1426 may include check boxes 1430 or the like for different managers to indicate their approval of information presented.

Each row of the table 1428 may correspond to an entity type and each column may include a column heading labeled to identify the different information or data contained in the cells of each column. Examples of the labeled columns and data or information contained in the cells may include an “*” column 1432 to select an entity type for presentation of entity details, an “Entity Type” column 1434, an “Actual Hours” column 1436, an “Estimated Hours” column 1438, a “% Error (Hours) column 1440, an “Actual Cost” column 1442, an “Estimated Cost” column 1444, a “% Error (Cost)” column 1446 and an “Add/Edit Actual” column 1448 or other columns for similar or related data or information. In % Error (Hours) column 1440 and % Error (Cost) column 1446, the value may be presented or displayed in red or otherwise highlighted if the value falls outside of a predetermined threshold. This predetermined threshold value may reside within a database. A user may click-on” an edit icon 1450 in the “Add/Edit Actual” column 1448 and assign text comments to explain why the value is outside of the threshold. The text comments may be added in a comments field in an “Add Entity” GUI (not shown) that may be presented in response to “clicking-on” the edit icon 1450. These comments will be saved and can be viewed or presented in a box (not shown) in response to the mouse hovering over the red or highlighted values in the % Error columns 1440 and 1446.

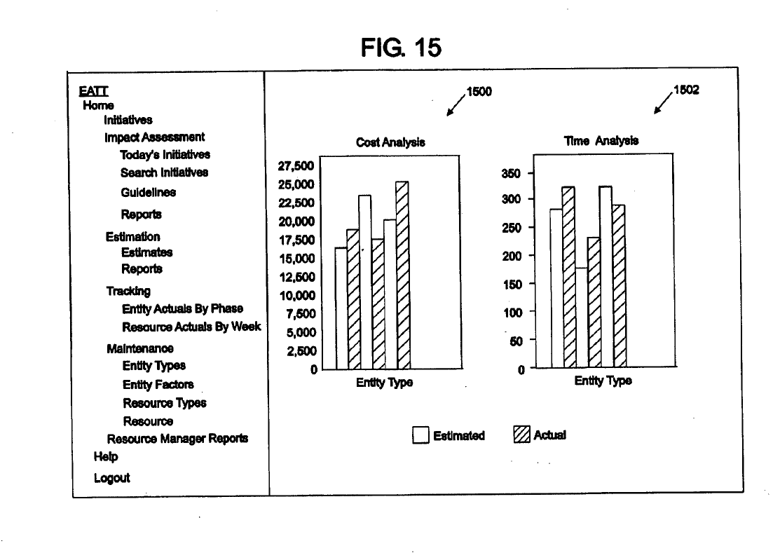

FIG. 15 is an example of a cost trend analysis chart 1500 and a time trend analysis chart 1502 generable by an estimates to actuals tracking tool and process in accordance with an embodiment of the present invention. The cost trend analysis chart 1500 and the time trend analysis chart 1502 may be presented in response to “clicking-on” or activating a link 1452 that may be labeled “Trend Analysis by Phase” or the like in GUI 1400 in FIG. 14. The charts 1500 and 1502 may each be a bar chart with entity type being represented on the horizontal axis and cost or time being represented, respectively, on the vertical axis. Each bar chart may include actual data and estimated data side-by-side for each entity type for comparison purposes.

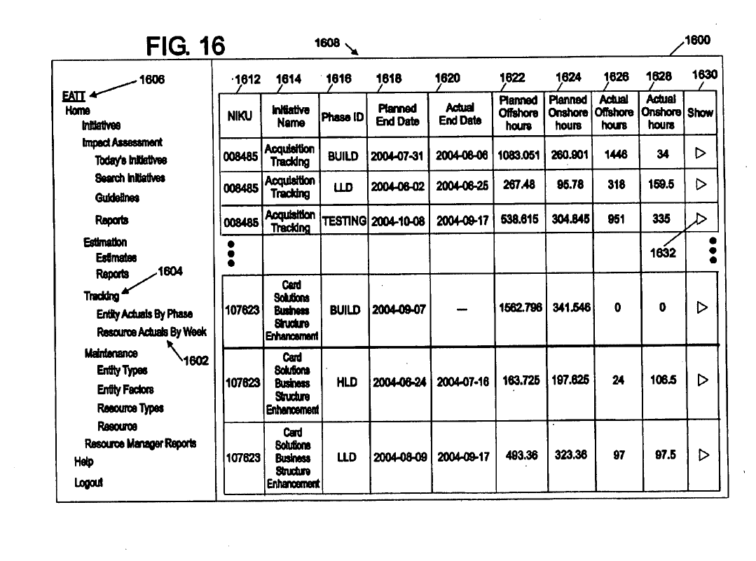

FIG. 16 is an example of an “Initiatives Details” GUI 1600, web page or the like of an estimates to actuals tracking tool and process for presenting resource actual data by week in accordance with an embodiment of the present invention. The “Initiatives Details” GUI 1600 for presenting resource actuals by week may be presented in response to “clicking-on” or otherwise activating a link 1602 under a “Tracking” subheading 1604 in an EATT menu 1606. The EATT menu 1606 may be the same as EATT menu 204 in GUI 200 (FIG. 2). The GUI 1600 may include a table 1608 presenting the resources actual data by week. Each row 1610 may correspond to a different “NIKU” or database. Each column may be labeled with a description of the data or information contained in each cell in the column. Examples of the different columns and data contained within each of the cells may include an “NIKU” column 1612, an “Initiative Name” column 1614, a “Phase ID” column 1616, a “Planned End Date” column 1618, an “Actual End Date” column 1620, a “Planned Offshore hours” column 1622, a “Planned Onshore hours” column 1624, an “Actual Offshore hours” column 1626, an “Actual Offshore hours” column 1628 and a “Show” column 1630.

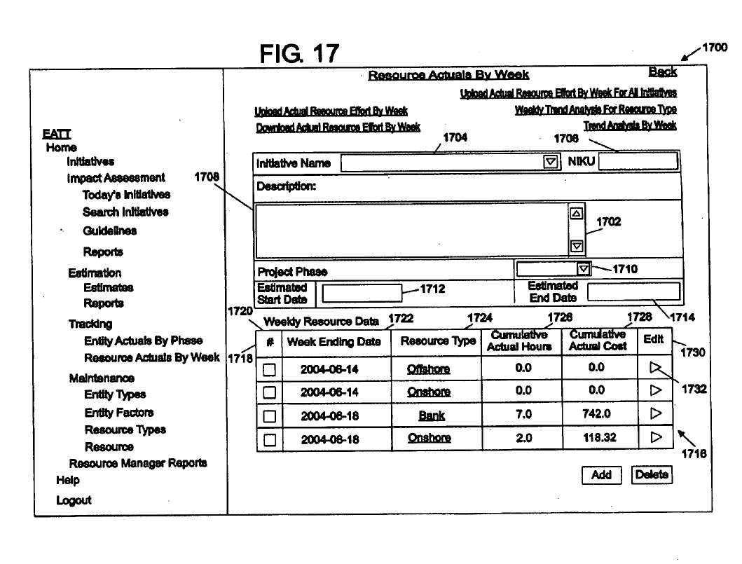

FIG. 17 is an example of an of a “Resource Actuals by Week” GUI 1700, web page or the like of an estimates to actuals tracking tool and process in accordance with an embodiment of the present invention. The “Resource Actuals by Week” GUI 1700 may be presented in response to “clicking-on” or activating one of the links or icons 1632 in the “Show” column 1630 of GUI 1600 (FIG. 16). The “Resource Actuals by Week” GUI 1700 may include a first section 1702 with a plurality of fields. Examples of the fields may include an “Initiative Name field 1704, an “NIKU” field 1706, a “Description” field 1708, a “Project Phase” field 1710, an “Estimated Start Date” field 1712, an “Estimated End Date” field 1714 or similar fields to identify or specify the resource actual data. The resource actual data may be presented in a table 1716. The table 1716 may include a plurality of rows 1718. Each row may correspond to a different resource. The table 1716 may also include a plurality of columns. Each column may be labeled with a description of the data or information contained in each cell in the column. Examples of the different columns and data contained within each of the cells may include a “#” column 1720, each containing a box to select the corresponding resource, a “week Ending Date” column 1722, a “Resource Type” column 1724, a “Cumulative Actual Hours” column 1726, a “Cumulative Actual Cost” column 1728, an “Edit” column 1730 or other columns and data that may be used to describe or specify a resource.

An “Update Weekly Data” CUI or screen shot (not shown in the drawings) may be presented in response to “clicking-on” or activating a link or icon 1732 in the “Edit” column 1732. The “Update Weekly Data” GUI may include a plurality of fields to specify or describe a resource. Examples of the fields may include an “Initiative Name” field, an “NIKU” field, a “Week End Date” field, a “Resource Type” field, an “Actual Hours” field or similar fields that may be used to specify or describe a resource.

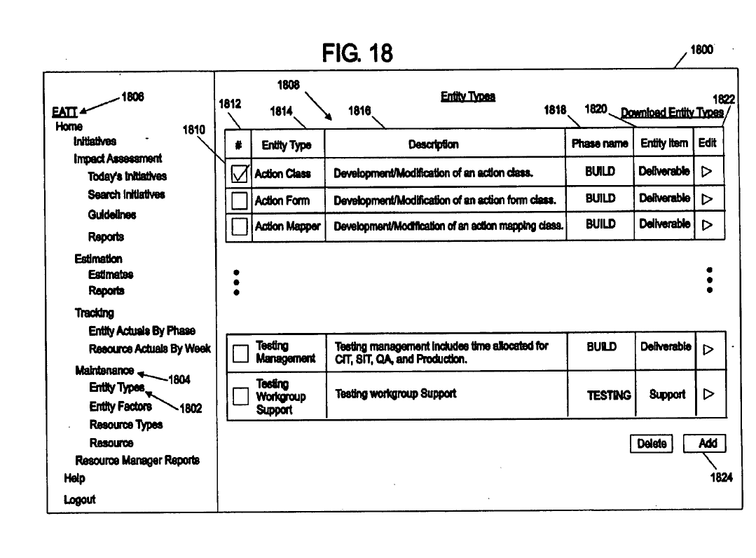

FIG. 18 is an example of an “Entity Types” maintenance GUI 1800, web page or the like of an estimates to actuals tracking tool and process to add, edit or delete entity details in accordance with an embodiment of the present invention. The “Entity Types” GUI 1800 may be presented in response to “clicking-on” or activating an “Entity Types” link 1802 under a “Maintenance” subheading 1804 of an EATT menu 1806 for maintaining the estimates to actuals tracking tool. The EATT menu 1806 may be the same as EATT menu 204 in FIG. 2. The “Entity Types” GUI 1800 may include a table 1808. Each row 1810 of the table 1808 may represent an entity type and each column may be labeled to identify the data or information contained in each cell beneath the column heading. Examples of the different data or information and corresponding column may include a “#” column 1812 for electing an entity type to display or present the details associated with the entity, an “Entity Type” column 1814, a “Description” column 1816, a “Phase name” column 1818, an “Entity item” column 1820 and an “Edit” column 1822.

An “Entity Type Add View” GUI (not shown in the drawings) may be presented by “clicking-on” or otherwise activating a button 1824 or the like, that may be labeled “Add” or similar descriptive label. The GUI may include a plurality of fields to enter or select parameters related to an entity or entity type. Examples of the different fields may include an “Entity Type” field, a “Description” field, a “Phase Name” field, an “Entity Item” field or similar fields for entering or selecting parameters to identify an entity or entity type. The parameters or information entered or selected may be saved by “clicking-on” or otherwise activating a “Save” button or the like.

An “Update Entity Type View” GUI (not shown in the drawings) may be presented in response to “clicking-on” or otherwise activating the symbol or icon in the “Edit” column 1822 for one of the rows 1810 of entity types to be updated or edited in “Entity Types” GUI 1800 (FIG. 18). The “Update Entity Type View” GUI may include similar fields to those described with respect to the “Entity Type Add View” GUI just described. Examples of the fields may include an “Entity Type” field, a “Description” field, a “Phase Name” field, an “Entity Item” field or the like.

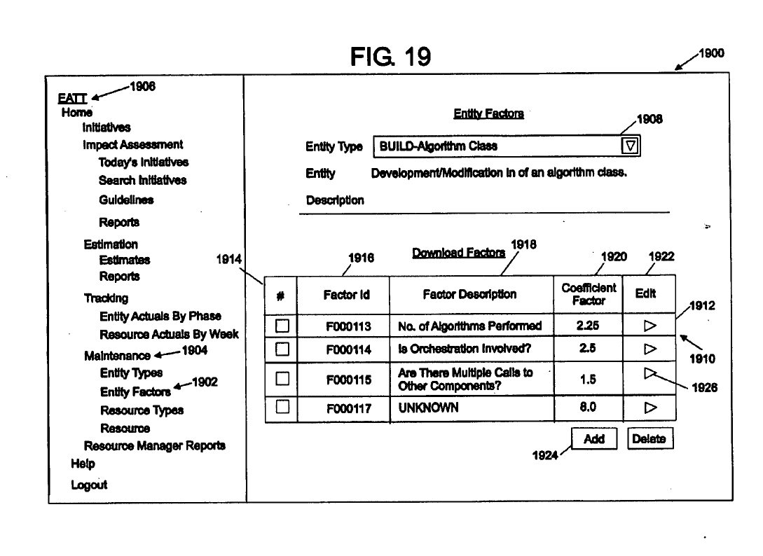

FIG. 19 is an example of an “Entity Factors” GUI 1900, web page or the like of an estimates to actuals tracking tool and process to add, edit or delete factors associated with an entity in accordance with an embodiment of the present invention. The “Entity Factors” GUI 1900 may be presented by “clicking-on” or otherwise activating an “Entity Factors” link or the like under a “Maintenance” subheading 1904 in an EATT menu 1906. The EATT menu 1906 may be the same as the EATT menu 204 of FIG. 2. The GUI 1900 may include a field 1908 to enter or select an entity type. The GUI 1900 may also include a table 1910 to present different parameters or information related to the entity type entered in field 1908. Each row 1912 of the table 1910 may correspond to a different factor. Each column may be labeled in a heading by a description of the parameter or information contained in each cell under the column heading. Examples of the different column heading labels and corresponding parameters or data may include a “#” column 1914 to select a factor to present more detailed information, a “Factor Id” column 1916, a “Factor Description” column 1918, a “Coefficient Factor” column 1920, an “Edit” column 1922 or similar columns for other parameters or data that may be used to specify a factor.

A “Factor Add View” GUI (not shown in the drawings) may be presented in response to “clicking-on” or otherwise activating an “Add” button 1924 or the like in GUI 1900 (FIG. 19). The “Factor Add View” may include fields to enter or select parameters, values or information related to an entity factor. Examples of the fields may include a “Factor Description” field, a “Coefficient Factor” field, a “Factor Type” field or other fields for similar factors related to an entity. Examples of “Factor Types” may include a “Textbox” and a “Checkbox” that may be selected. The parameters entered in each of the fields may be saved by “clicking-on” or otherwise activating a “Save” button or the like.

An “Update Factors” GUI (not shown in the drawings) may include similar fields to the “Factor Add View” GUI. For example, a “Factor Description” field, a “Coefficient Factor” field, a “Factor Type” field or the like may be presented. The updated fields may be saved by “clicking-on” or activating a “Save” button or the like.

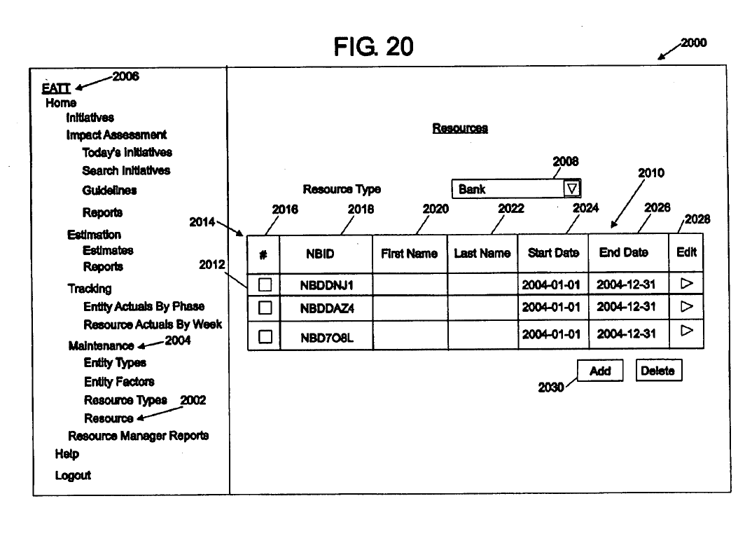

FIG. 20 is an example of a “Resources” GUI 2000, web page or the like of an estimates to actuals tracking tool and process to add, edit or delete resources in accordance with an embodiment of the present invention. The “Resources” GUI 2000 may be presented in response to “clicking-on” or otherwise activating a “Resources” link 2002 that may be under a “Maintenance” subheading 2004 in an EATT menu 2006. The EATT menu 2006 may be similar to the EATT menu 204 of GUI 200 (FIG. 2). The “Resource” GUI 2000 may include a “Resource Type” field 2008 in which a resource type may be entered or selected. Parameters or information related to the resource type in “Resource Type” field 2008 may be presented in a table 2010. Each row 2012 of the table 2010 may correspond to a resource. Each column of the table 2010 may be labeled in a heading 2014 with a description of the parameter or information in each cell of the table 2010 related to the resource. Examples of the parameters or information and labeling for each column may include a “#” column 2016 that may include checkboxes 2017 or the like to select a resource 2012 to display more detailed information about the resource or to edit information related to the resource, an “NBID” column 2018, a “First Name” column 2020, a “Last Name” column 2022, a “Start Date” column 2024, an “End Date” column 2026, an “Edit” column 2028 or similar columns. “NBIB” may be a unique identification number/letter combination identifying each employee of an organization or entity.

An “Add Resource” GUI (not shown in the drawings) may be presented in response to “clicking-on” or activating an “Add” button 2030 in “Response” GUI 2000 (FIG. 20). The “Add Resource” GUI may include a plurality of fields to enter or select parameters or information related to a resource to be added. Examples of the different fields may include a “NBID” field, a “Resource Type” field, a “First Name” field, a “Last Name” field, a “Start Date” field, an “End Date” field, a “Role” field, or other fields for similar parameters or information related to a resource. The parameters, values or information entered or selected in the fields may be saved by “clicking-on” or activating a “Save” button.

An “Update Resource” GUI (not shown in the drawings) may be presented in response to “clicking-on” or activating a symbol or icon for a resource 2012 in the “Edit” column 2028 in the “Resources” GUI 2000 (FIG. 20). The “Update Resource” GUI may include similar fields to the “Add Resource” GUI to update any parameters or information associated with a resource. Examples of the fields may include a “Resource Type” field, a “First Name” field, a “Last Name” field, a “Start Date” field, an “End Date” field, a “Role” field, or similar fields. The updated parameters or information may be saved by “clicking-on” or otherwise activating a “Save” button or the like.

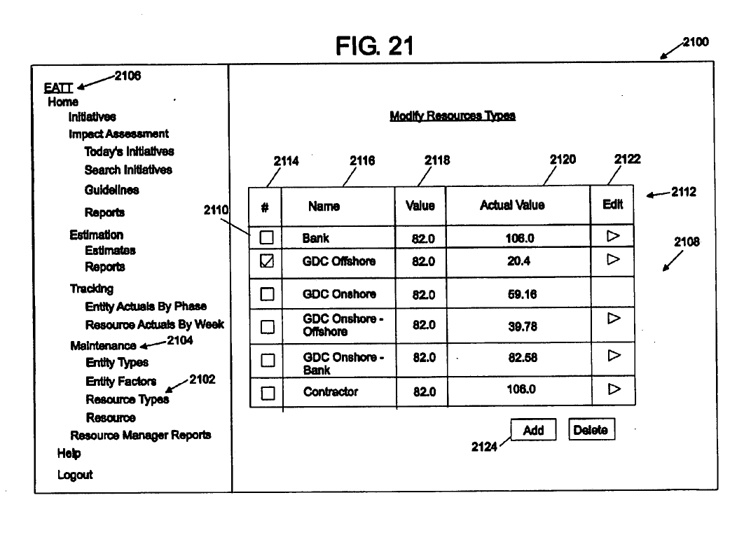

FIG. 21 is an example of a “Modify Resource Types” GUI 2100, web page or the like of an estimates to actuals tracking tool and process to modify resource type information in accordance with an embodiment of the present invention. The “Modify Resource Types” GUI 2100 may be presented by “clicking-on” or activating a “Resource Types” link 2102 under a “Maintenance” subheading 2104 in an EATT menu 2106. The EATT menu 2106 may be similar to the EATT menu 204 of FIG. 2. The “Modify Resource Types” GUI 2100 may include a table 2108 containing parameters, values or information related to resource types. Each row 2110 may correspond to a resource type. Each column may be labeled in a column heading 2112 with a descriptive label of the parameter, value or information contained in each cell of the column. Examples of the different parameters, values or information and column labels may include a “#” column 2114 in which each cell may contain a checkbox that may be selected to provide more detailed information related to the resource type, a “Name” column 2116, a “Value” column 2118, an “Actual” value column 2120, an “Edit” column 2122, or other columns for values or information related to a resource type.

A “Maintenance Resource Types” GUI (not shown in the drawings) may be presented in response to “clicking-on” or activating an “Add” button 2124 or the like in GUI 2100 (FIG. 21). The “Maintenance Resource Types” GUI may include a plurality of fields to enter or select information related to a resource type. Examples of the fields and different information that may be entered or selected related to a resource type may include a “Name” field, a “Value” field, an “Actual Value” field, or other fields for information or parameters related to a resource type.

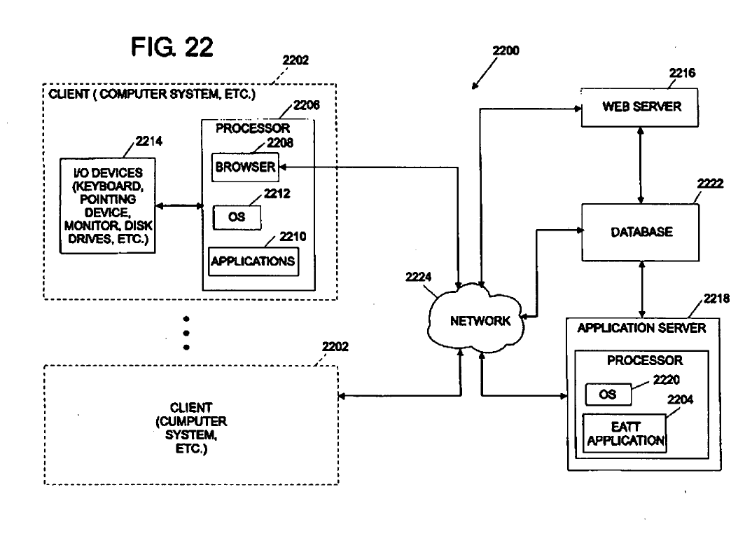

FIG. 22 is a block diagram of exemplary system 2200 that may incorporate an estimates to actuals tracking tool or the like in accordance with an embodiment of the present invention. The method 100 may be embodied in the system 2200 and may the system 2200 may generate the GUIs and reports similar to those discussed with respect to FIGS. 2-34. The system 2200 may include one or more clients 2202. The client 2202 may be a computer system or other data processing or communication device capable of accessing an estimates to actuals tracking tool (EATT) application 2204 or the like and presenting the different GUIs and reports. The client 2202 may include a processor 2206. A browser 2208, such as a web browser or the like, may be operable on the processor 2206. Other applications 2210 may also be operable on the processor 2206 to facilitate accessing the EATT application and permit a user to interface with the different GUIs that may be presented. An operating system 2212 may also be operable on the processor to control overall operation of the client components and the browser 2208 and other applications 2210.

The client 2202 may also include input devices, output devices or combination input/output devices, collectively I/O devices 2214. Examples of the I/O devices 2212 may include a keyboard or keypad, a computer pointing device, such as a mouse or the like, a monitor or display to permit a user to interface with the EATT application 2204. Other examples of the I/O devices 2214 may include disk drives or similar I/O devices to receive computer readable media or the like.

The system 2200 may also include a web server 2216 and an application server 2218 or the like. The EATT application 2204 may be operable on the application server 2218. The application server 2218 may include a processor on which the EATT application 2204 may be operable and may include other components for operation of the EATT application 2204. An operating system may also be operable on the processor 2218 to control overall operation of the application server 2218, the EATT application 2204 and any other components of the application server.

The system 2200 may also include a database 2222. The web server 2216 and application server 2218 may access the database similar to that described with in method 100 of FIG. 1.

The different components of the system 2200 may communicate with one another via a network 2224. The network may the Internet, intranet or similar private network or the like. The network 2216 may include communications links or channels that may be wired or wireless or may contain portions that may be wired or wireless.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more features, integers, steps, operations, elements, components, and/or groups thereof.

While the examples used in describing the present invention may be related to the banking or financial industry, the principles and features of the present invention may be adapted to any business or industry were determining the effectiveness of a compliance program may be important.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for estimating parameters and tracking actual parameters for an initiative, comprising:
estimating a parameter for the initiative based on responses to a set of questions; and
tracking actual data for the parameter during progression of the initiative.

2. The method of claim 1, wherein estimating a parameter comprises:
estimating a number of hours; and
estimating a cost.

3. The method of claim 1, further comprising tracking data by phase, release and resource.

4. The method of claim 1, further comprising tracking resources by initiative and availability.

5. The method of claim 1, further comprising presenting actual data for the parameter compared to the estimate for the parameter.

6. The method of claim 1, further comprising running a report in response to a user selecting a report option, wherein the report option includes a weekly report option and an initiative report option.

7. The method of claim 1, further comprising presenting an initiative GUI in response to selecting an initiative option in a menu, wherein the initiative GUI includes at least one of an initiative name, and initiative description, a current phase, an initiative status and an impact analysis for each initiative.

8. The method of claim 1, further comprising presenting an estimates GUI in response to selecting an estimates option in a menu, wherein the estimates GUI includes at least one of a description, an entity type, a total number of hours estimate, a resource type and a cost estimate for each entity.

9. The method of claim 8, further comprising classifying each entity into a set of classifications including deliverables, SSP activities and management activities.

10. The method of claim 1, further comprising presenting an add entity GUI to add a new entity, wherein the add entity GUI includes at least one of:
a description field;
an entity type field;
a complexity determination function;
a total hours estimate field;
an override comments field;
a resource type field;
a rate field; and
a cost field.

11. The method of claim 1, further comprising determining a total number of hours estimate for an entity based on a set of predetermined factors, wherein the predetermined factors include at least one of:
a number of input objects;
a number of output objects; and
a number of application programming interfaces.

12. The method of claim 1, further comprising presenting an impact assessment in response to selecting an impact assessment option in a menu.

13. The method of claim 1, further comprising presenting a maintenance GUI for maintaining an estimates to actuals tracking tool in response to selecting a maintenance option in a menu.

14. An estimates to actuals tracking tool, comprising:
a data structure operable on a processor to estimate a parameter for an initiative based on responses to a set of questions; and
a data structure operable on the processor to track actual data for the parameter during progression of the initiative.

15. The estimates to actuals tracking tool of claim 14, wherein the data structure to estimate the parameter comprises:
a data structure to estimate a number of hours; and
a data structure to estimate a cost.

16. The estimates to actuals tracking tool of claim 14, further comprising a data structure to track data by phase, release and resource.

17. The estimates to actuals tracking tool of claim 14, further comprising a data structure to present actual data for the parameter compared to the estimate for the parameter.

18. The estimates to actuals tracking tool of claim 14, a data structure to generate a report in response to a user selecting a report option, wherein the report option includes a weekly report option and an initiative report option.

19. The estimates to actuals tracking tool of claim 14, further comprising a data structure to present an initiative GUI in response to selecting an initiative option in a menu, wherein the initiative GUI includes at least one of an initiative name, and initiative description, a current phase, an initiative status and an impact analysis for each initiative.

20. The estimates to actuals tracking tool of claim 14, further comprising a data structure to present an estimates GUI in response to selecting an estimates option in a menu, wherein the estimates GUI includes at least one of a description, an entity type, a total number of hours estimate, a resource type and a cost estimate for each entity.

21. The estimates to actuals tracking tool of claim 14, further comprising a data structure to present an add entity GUI to add a new entity, wherein the add entity GUI includes at least one of:
a description field;
an entity type field;
a complexity determination function;
a complexity determination override function;
a total hours estimate field;
an override comments field;
a resource type field;
a rate field; and
a cost field.

22. The estimates to actuals tracking tool of claim 14, further comprising a data structure to determine a total number of hours estimate for an entity based on a set of predetermined factors, wherein the predetermined factors include at least one of:
a number of input objects;
a number of output objects; and
a number of application programming interfaces.

23. The estimates to actuals tracking tool of claim 14, further comprising a data structure to present an impact assessment in response to selecting an impact assessment option in a menu.

24. A computer program product for estimating parameters and tracking actual parameters for an initiative, the computer program product comprising:
a computer readable medium having computer readable program code embodied therein, the computer readable medium including:
computer readable program code configured to estimate a parameter for an initiative based on responses to a set of questions; and
computer readable program code configured to track actual data for the parameter during progression of the initiative.

25. The computer program product of claim 24, further comprising computer readable program code configured to track data by phase, release and resource.

26. The computer program product of claim 24, further comprising computer readable program code configured to generate a report in response to a user selecting a report option, wherein the report option includes a weekly report option and an initiative report option.

27. The computer program product of claim 24, further comprising computer readable program code configured to present actual data for the parameter compared to the estimate for the parameter.

28. The computer program product of claim 24, further comprises computer readable program code configured to present an initiative GUI in response to selecting an initiative option in a menu, wherein the initiative GUI includes at least one of an initiative name, and initiative description, a current phase, an initiative status and an impact analysis for each initiative.

29. The computer program product of claim 24, further comprising computer readable program code configured to present an estimates GUI in response to selecting an estimates option in a menu, wherein the estimates GUI includes at least one of a description, an entity type, a total number of hours estimate, a resource type and a cost estimate for each entity.

30. The computer program product of claim 24, further comprising computer readable program code configured to determine a total number of hours estimate for an entity based on a set of predetermined factors, wherein the predetermined factors include at least one of:
a number of input objects;
a number of output objects; and
a number of application programming interfaces.

31. The computer program product of claim 24, further comprising computer readable program code configured to present an impact assessment in response to selecting an impact assessment option in a menu.
